(19) United States
(12) Patent Application Publication
(10) Pub. No.: US 2012/0135323 A1
(43) Pub. Date: May 31, 2012

(54) LOW-TEMPERATURE FUEL CELL HAVING AN INTEGRATED WATER MANAGEMENT SYSTEM FOR PASSIVELY DISCHARGING PRODUCT WATER

(75) Inventors: Kolja Bromberger, Freiburg (DE); Christian Koenig, Freiburg (DE); Volker Ackermann, Tirschenreuth (DE)

(73) Assignee: FRAUNHOFER-GESELLSCHAFT ZUR FORDERUNG DER ANGEWANDTEN FORSCHUNG E.V., Munchen (DE)

(21) Appl. No.: 13/254,672

(22) PCT Filed: Mar. 2, 2010
(86) PCT No.: PCT/EP2010/001285

§ 371 Date: Feb. 13, 2012

(30) Foreign Application Priority Data
Mar. 2, 2009 (DE) 10 2009 011 239.1

(51) Int. Cl. H01M 8/06; H01M 8/04

(52) U.S. Cl. 429/414

(57) ABSTRACT

A low-temperature fuel cell having an integrated water management system for passive discharge of product water includes at least one membrane-electrode assembly having at least one anode-side and one cathode-side electrode and at least one membrane disposed between the electrodes, current collector structures disposed on the anode-side and cathode-side and distribution structures for fuel and oxidant disposed on the anode-side and cathode-side. The cathode-side distribution structure hereby has a capillary structure for transporting away the product water and also gas supply channels.

### CROSS-REFERENCE TO RELATED APPLICATIONS

The present application is a national phase application of PCT/EP2010/001285, filed pursuant to 35 U.S.C. §371, which claims priority to De 10 2009 011 239.1, filed Mar. 2, 2009. Both applications are incorporated herein by reference in their entirety.

### TECHNICAL FIELD

The invention relates to a low-temperature fuel cell having an integrated water management system for the passive discharge of product water.

### BACKGROUND

The PEMFC belongs to the group of low-temperature fuel cells which operate at temperatures below 100° C. The core part of the PEMFC is the MEA (membrane electrode assembly). The membrane separates the anode and cathode electrically and fluidically from each other. A catalytically active electrode is applied on both sides of the membrane. The electrochemical reactions take place there. The electrons produced during the anode-side, electrochemical conversion of hydrogen flow via the outer current circuit from the anode to the cathode. Because of the applied potential difference, the remaining protons diffuse from the anode through the proton-conductive membrane to the cathode. Atmospheric oxygen is reduced at the catalytic electrode of the cathode. Together with the protons and the electrons, water, which is present in the low-temperature range completely in liquid phase, is produced. The ionic conductivity of the cell membrane is dependent upon the water content in the membrane. In the case of optimum saturation of the membrane with water, the proton-conducting channels are configured completely in one membrane. Non-converted gases emerge at the anode or cathode as residual combustible gas or residual air.

Passive micro-fuel cells in the low power range have specific requirements for the cell design which favor planar construction. In the case of this construction, all the individual fuel cells are disposed in the same plane and are connected to each other electrically. In the case of the passive fuel cell, the anode is supplied with air actively and the cathode is supplied with air passively, i.e. through openings in the housing of the cathode side. The so-called self-breathing cell thus draws the oxygen from the ambient air independently. In general, the following requirements are placed upon the gas distributor structure (flow field)
homogeneous distribution of the reactants on the entire cell surface,
collection and discharge of reaction water without impeding the gas supply,
mechanical stability in order to transmit contact pressures permanently and as homogeneously as possible to other cell components.

Assuming that, at the operating temperature of the fuel cell, the reaction water can evaporate completely into the environment through openings in the cathode flow field, the collection and discharge of reaction water has to date been achieved in the same gas supply channel. This presumes a large opening ratio of the cathode surface at the expense of reducing the mechanical stability of the flow field and affecting the current collection negatively. The opening ratio of the cathode is defined as the ratio of the entire area of the openings to the entire active MEA surface. During load operation of the fuel cell in high power ranges, increasing wetting of the catalytically active material with excess water takes place because of the electrochemical reactions. More water is produced than the previous passive flow field, corresponding to the state of the art, can discharge. As a consequence, individual gas supply channels are wetted in part completely with product water and the oxygen supply becomes blocked. The active surface which is available thereby becomes smaller and the efficiency of the cell reduces.

The water management has been resolved to date by cathode- or anode-side recirculation (U.S. Pat. No. 6,015,634 A), by means of a special flow field for water discharge (U.S. Pat. No. 7,063,907 B2, U.S. Pat. No. 6,916,571 B2, U.S. Pat. No. 6,187,466 B1) or by means of capillary material (U.S. Pat. No. 6,015,633 A, US 2008/0032169 A1, US 2007/0284253 A1).

### SUMMARY

In some embodiments, the present invention provides a low-temperature fuel cell having an integrated water management system by which more efficient transport away of the liquid product water is made possible without thereby impairing the gas supply to the cathode.

According to some embodiments of the invention, a low-temperature fuel cell for the passive discharge of liquid product water is provided, which fuel cell has at least one membrane-electrode assembly which has in turn at least one anode-side and one cathode-side electrode and also at least one membrane disposed between the electrodes. Furthermore, the fuel cell has current collector structures disposed on the anode-side and the cathode-side and also has distribution structures for fuel and oxidant disposed on the anode-side and cathode-side.

The invention is distinguished by the cathode-side distribution structure having gas supply channels and at least one capillary structure for transporting product water away from the cathode, the capillaries of the capillary structure having a hydraulic diameter which allows transporting the product water away through the capillaries via capillary force.

In order to improve the water management in the low-temperature fuel cell, a passive approach to the discharge of excess product water is made possible. The passive water discharge increases the efficiency of the fuel cell above all with respect to long-term operation. Furthermore, the operating reliability of the PEMFC is significantly increased since the oxygen transport towards the gas diffusion layer is improved, the catalyst layer is not wetted excessively with product water and the gas supply channels of the cathode flow field remain free. The fuel cell according to the invention is likewise distinguished by wetting of the individual gas supply channels being essentially prevented, as a result of which optimum supply of the cathode with the oxidant is ensured. The entire available active surface can thereby be used for current production. Because of the passive concept, auxiliary energy is required neither in electrical nor in thermal form for the water discharge. Likewise, additional equipment, such as further distribution structures, ventilators, fans or water separators, can be dispensed with.

In some embodiments, the gas supply channels of the fuel cell according to the invention have a cross-section that deviates from a circular cross-section in individual regions. There are included herein for example, corners, oval tapering bulges and the like. It is thereby not required that all the gas supply channels have the same cross-section, rather it is possible that the individual gas supply channels have different geometries. As a result of this geometry, it is possible to optimize transporting liquid reaction water away from the gas diffusion layer to the upper side of the cathode flow field and to optimize transport of oxygen from the environment to the gas diffusion layer. In some embodiments, the capillaries have a round cross-section—but are not restricted hereto—which ensures the transport away by means of capillary force.

In some embodiments, the gas supply channels and also the capillaries have an oval, rectangular, square, hexagonal, triangular, star-shaped or trapezoidal cross-section. Also geometric intermediate shapes between the above-mentioned variants are conceivable.

In some embodiments, the gas supply channels have a diameter in the range of 500 μm to 5 mm. In some embodiments, the gas supply channels have a diameter in the range of 0.8 to 2 mm.

In some embodiments, the capillaries have a diameter in the range of 100 μm to 1 mm. In some embodiments, the capillaries have a diameter in the range of 150 μm to 300 μm.

The above-mentioned diameters are not restricted to the mentioned ranges. Essentially, the diameters of the gas supply channels and of the capillaries depend upon the following points: wetting angle, required height of rise, opening ratio, contact pressure, mechanical properties, choice of material and also achievable structural sizes as a function of the manufacturing technology.

In some embodiments, the gas supply channels and the capillaries of the capillary structure are disposed spatially separated from each other.

In some embodiments, capillaries are disposed in the regions of the gas supply channels that deviate from the round cross-section. For example, in the case of a gas supply channel with a hexagonal cross-section, the capillaries that have a round diameter are disposed in the corners of the hexagon.

In some embodiments, a distribution region for accelerating evaporation of the product water is disposed at least in regions on the surface of the capillary structure orientated away from the electrode. The distribution region is located on the cathode-side surface and has a readily wettable surface and/or a hydrophilic distribution medium. In some embodiments, the distribution region has a structured surface. Good wettability can be achieved by a chemical or mechanical surface processing, a channel structuring, an additional coating (distribution medium) or a capillary material (distribution medium), such as microporous foam, textile, fleece or similar. In some embodiments, the distribution region has good thermal conductivity so that evaporation of the product water in the distribution region is assisted via the reaction heat of the PEMFC. In some embodiments, a distribution medium for optimizing transporting product water away from the cathode is disposed in the regions of the gas supply channels that deviate from the round cross-section, e.g. in the corners.

According to some embodiments of the invention, a method for transporting away the product water in a low-temperature fuel cell is likewise provided, as was described previously, in which the length and the diameter of the capillaries is chosen in the ratio to the diameter of the gas supply channels such that transporting the product water through the capillaries is effected via capillary force and by evaporation of the product water on the surface of the capillary structure orientated away from the electrode by means of evaporation suction.

### BRIEF DESCRIPTION OF THE FIGURES

The subject according to the invention is intended to be explained in more detail with reference to the subsequent Figures without wishing to restrict this to the special embodiments shown here.

FIG. 1 shows three variants of a fuel cell according to the invention in a plan view.

FIG. 2 shows gas supply channels according to the invention in a plan view.

FIG. 3 shows three variants of a fuel cell according to the invention in combination with a distribution medium in plan view.

FIG. 4 shows a cross-section of the fuel cell according to the invention with reference to three variants.

### DETAILED DESCRIPTION

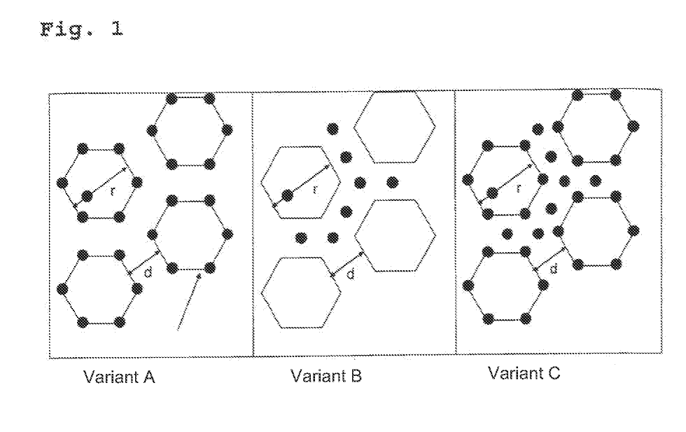

The arrangement according to the invention represents the cathode-side with gas supply channels and also additional capillaries for the water discharge. The arrangement of the gas supply channels and the capillaries can be configured in different variants, as shown in FIG. 1. A plan view on the planar passive cathode-side for hexagonal gas supply channels and round capillaries is represented in three variants by way of example. The geometry of the gas supply channels and of the capillaries is thereby not restricted to hexagonal or round geometries but can also be configured to be oval, rectangular, triangular, star-shaped, trapezoidal or from combinations hereof. The gas supply channel can be configured differently in the spacing d and also in the radius r. The spacings and radii of the capillary are likewise variable.

Variant A shows additional capillaries respectively in the corners of the hexagonal channel, which capillaries receive the liquid water from the air opening and transport it to the surface. Variant B shows the hexagonal channel geometry without side channels. The water discharge takes place in the web region through the capillaries.

In addition, a part of the forming water is discharged via the corner regions of the gas supply channels. In some embodiments, a homogeneous transporting away of the liquid water through the large number of capillaries can take place via the gas diffusion layer (GDL) in the web region. Variant C combines variants A and B. The advantage resides in the fact that an effective water discharge is possible via the entire gas diffusion layer.

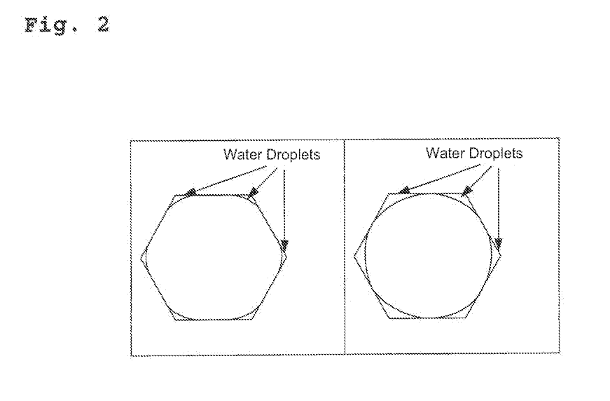

It is common to all variants that a certain wetting takes place in the corners of the gas supply channels as a function of the geometry and of the wetting angle. The hexagonal geometry of the gas supply channels hereby has a particularly suitable structure for concentrating liquid water in the corners. This state of affairs is represented in FIG. 2.

According to the geometry and wetting angle, this leads to a reduction in the opening ratio. Additional channels are introduced respectively therefore at the corners (apart from in variant B) and have a significantly smaller hydraulic diameter in comparison with the gas supply channels. Hence it is ensured that the liquid phase reaches the side channel from the gas diffusion layer by means of the capillary force and is filled independently up to the end of the capillary on the surface of the cathode-side distribution structure.

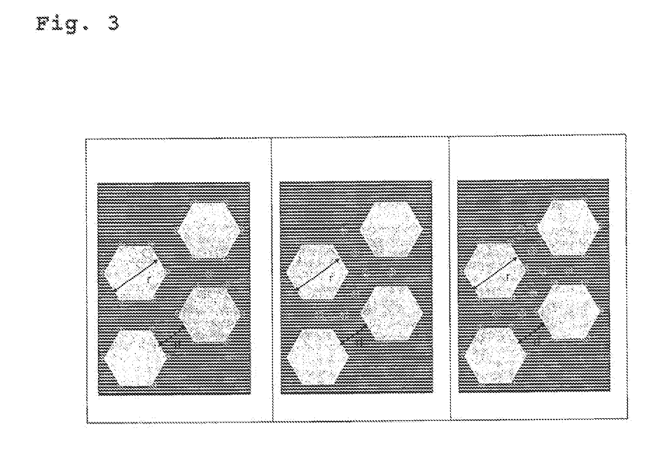

The water evaporates on the surface to the environment. A distribution medium or a suitable surface processing or surface structuring of the capillary structure can be used to increase the evaporation area substantially, the liquid water from the corners and the capillaries being absorbed by it and distributed on the entire upper-side. In some embodiments, the distribution medium may be a hydrophilic fleece or the like. For this purpose, three variants can be configured (see FIG. 3). On the one hand, the distribution medium or the surface processing or surface structuring is applied directly on the web, the openings being open for the air transport. Both the corners of the gas supply channels and the capillaries are thereby covered by the distribution medium in order to ensure a water discharge from the corners or the capillaries into the distribution medium.

On the other hand, the distribution medium or the surface processing or surface structuring can be situated both in the region of the webs and on the gas supply channels. In the last-mentioned variant, it must be ensured that the air permeability of the distribution medium in the region of the gas supply channels is sufficiently good so that the discharged water does not impede the air supply or indeed make it worse.

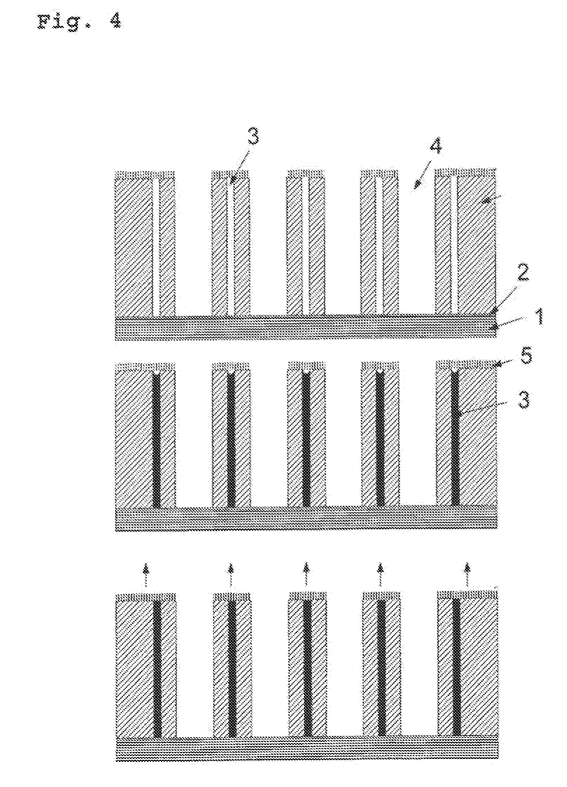

FIG. 4 shows the cross-section of the cathode flow field. Water droplets 2 are formed on the gas diffusion layer 1 (FIG. 4, at the top), which collect and wet the capillaries 3 between the gas supply channels 4. The capillary force ensures independent filling of the capillaries up to the surface (FIG. 4 centre). The distribution material 5 absorbs the water from the capillaries and distributes it on the surface (FIG. 4, at the bottom). By means of evaporation, the water is discharged from the distribution medium. Hence continuous water can be discharged to the environment.

1-13. (canceled)

14. A low-temperature fuel cell having an integrated water management system for the passive discharge of product water, the fuel cell comprising:
at least one membrane-electrode assembly including:
at least one anode-side;
one cathode-side electrode; and
at least one membrane disposed between the electrodes;
current collector structures disposed on the anode-side and cathode-side; and
distribution structures for fuel and oxidant disposed on the anode-side and cathode-side, the cathode-side distribution structure having gas supply channels and at least one capillary structure for transporting away product water from the cathode, the capillary structure including capillaries having a hydraulic diameter that allows transporting away of the product water through the capillaries via capillary force.

15. The fuel cell of claim 14, wherein the gas supply channels have a cross-section with a geometry that deviates from a circular cross-section in regions, thereby enabling optimum oxygen supply to a gas diffusion layer and simultaneous optimum transporting away of product water.

16. The fuel cell of claim 15, wherein the gas supply channels have a cross-section shape selected from the group consisting of oval, rectangular, square, hexagonal, triangular, star-shaped, trapezoidal and combinations thereof.

17. The fuel cell of claim 14, wherein the capillaries have a cross-sectional shape selected from the group consisting of oval, rectangular, square, hexagonal, triangular, star-shaped, trapezoidal and combinations thereof.

18. The fuel cell of claim 14, wherein the gas supply channels have a diameter in the range of 500 μm to 5 mm.

19. The fuel cell of claim 14, wherein the gas supply channels have a diameter in the range of 0.8 mm to 2 mm.

20. The fuel cell of claim 14, wherein the capillaries have a diameter in the range of 100 μm to 1 mm.

21. The fuel cell of claim 14, wherein the capillaries have a diameter in the range of 150 μm to 300 μm.

22. The fuel cell of claim 14, wherein the gas supply channels and the capillaries of the capillary structure are spatially separated from each other.

23. The fuel cell of claim 14, wherein the capillaries are disposed in an edge region of the gas supply channels.

24. The fuel cell of claim 14, wherein a distribution medium for accelerating evaporation of the product water is disposed at least in regions on a side of the capillary structure orientated away from the electrode.

25. The fuel cell of claim 24, wherein the distribution medium has high heat conductivity in order to use reaction heat released in the fuel cell for evaporation of the product water.

26. The fuel cell of claim 14, wherein the capillary structure has a surface processing or surface structuring.

27. The fuel cell of claim 26, wherein a suitable surface processing or structuring has high heat conductivity in order to use reaction heat released in the fuel cell for evaporation of the product water.

28. The fuel cell of claim 23, wherein the capillaries in the edge region of the gas supply channels are provided themselves with a distribution medium for optimizing transport of the product water away from the cathode.

29. The fuel cell of claim 24, wherein the distribution medium includes one or more of a hydrophilic coating, a hydrophilic capillary material, microporous foam, textile, fleece, ceramic fiber, metal fiber, polymer fiber or natural fiber.

30. The fuel cell of claim 14, wherein a length and a diameter of the capillaries is chosen in a ratio to a diameter of the gas supply channels such that transporting away the product water through the capillaries occurs via capillary force and via evaporation of the product water on a surface of the capillary structure orientated away from the electrode via evaporation suction.
